(19) United States
(12) Patent Application Publication
(10) Pub. No.: US 2003/0018804 A1
(43) Pub. Date: Jan. 23, 2003

(54) Method and apparatus for deriving a standard MAC address from physical location

(76) Inventors: Amruth Laxman, Boca Raton, FL (US); Jack Bloch, Boca Raton, FL (US)

Correspondence Address: Siemens Corporation, Intellectual Property Department, 186 Wood Avenue south, Iselin, NJ, 08830, US

(21) Appl. No.: 10/115,453

(22) Filed: Mar. 28, 2002

Related U.S. Application Data
(60) Provisional application No. 60/279,295, filed on Mar. 28, 2001.
(60) Provisional application No. 60/279,279, filed on Mar. 28, 2001.

(51) Int. Cl. G06F 15/16

(52) U.S. Cl. 709/236

(57) ABSTRACT

A media access control (MAC) address is associated with a particular hardware location (e.g. slot) in the network rather than to the card itself. Thus, the card's MAC address assigned by the manufacturer is effectively ignored. When a card is first plugged into a slot, it is initialized with the MAC address of the slot. Thus, if a destination address in a received data frame matches the MAC address of the slot, the card will recognize the data frame. Likewise, when a Card transmits a data frame, the source address in the frame is changed to match the Slot MAC address prior to being sent over the network. This has the advantage that no update of additional databases/servers need be made upon hardware replacement. Further, it is very useful in identifying sources of messages or localizing faults in the communication network.

### DESCRIPTION

### CROSS REFERENCE TO RELATED APPLICATIONS

This application claims the benefit of priority under 35 U.S.C. 119(e) to two copending U.S. Patent Provisional Applications, Serial Nos. 60/279,295 and 60/279,279, both filed on Mar. 28, 2001, the contents of each of said applications being incorporated by reference herein.

This application is also related to the following U.S. patent applications: U.S. patent application Ser. No. ______ filed Mar. 28, 2002 entitled Distributed Architecture for a Telecommunications Software Switch; U.S. patent application Ser. No. ______ filed Mar. 28, 2002 entitled Distributed Architecture for a Telecommunications System; U.S. patent application Ser. No. ______ filed Mar. 28, 2002 entitled Method and Apparatus for a Messaging Protocol in a Distributed Telecommunications System; U.S. patent application Ser. No. ______ filed Mar. 28, 2002 entitled Method and Apparatus for Providing A Software Adaptation Layer in a Telecommunications System; U.S. patent application Ser. No. ______ filed Mar. 28, 2002 entitled Method and Apparatus for A Centralized Maintenance System within a Distributed Telecommunications Architecture; and U.S. patent application Ser. No. ______ filed Mar. 28, 2002 entitled Method and Apparatus for Providing a Proprietary Data Interface in a Distributed Telecommunications System, the contents of each of said applications being incorporated by reference herein.

### BACKGROUND OF THE INVENTION

1. Field of the Invention

The present invention generally relates to MAC addresses and, more particularly, to a system which identifies a MAC address with a particular slot address into which a card is plugged rather than to a particular card.

2. Background Description

A local area network (LAN) facilitates data communications among a plurality of connected terminals. Probably the most common LAN standard used world wide is the Ethernet, otherwise known as the IEEE 802.3 standard. The Ethernet uses a shared bus topology where all devices which are part of the network are connected to a common bus; usually comprising a twisted pair or a coaxial cable.

Ethernet uses a Carrier Sense Multiple Access (CSMA) protocol. Prior to transmitting a data packet, a terminal “listens” to determine whether the network is free or is being used by another terminal. Typically, all of the terminals have equal priority and begin transmitting if, after “listening”, the network is determined to be free. Once the transmission is initiated, the other terminals in the network will sense that the network is busy, and will refrain from transmitting. If two terminals begin to transmit simultaneously, what is known as a “collision” occurs. Therefore, the Ethernet network additionally includes CSMA with Collision Detection (CSMA/CD). The CD portion of the protocol specifies the steps taken to resolve the conflict when a collision occurs.

Every hardware device or terminal (hereinafter referred to simply as a “card”) connected to the network has its own unique address, commonly known as a Media Access Control address or “MAC” address. MAC addresses (which are physical addresses) are used for mapping in Transmission Control Protocol/Internet Protocol (TCP/IP) network communication. MAC addresses are 48 bits in length expressed as 12 hexadecimal digits (0-9 and A-F, capitalized). MAC addresses are usually expressed in octets (e.g., 01:23:45:67:8A:BC). In theory this providers 281,474,976,710,656 (base 10) addresses. Thus, as can be appreciated with this many possibilities, many cards can each be assigned a unique MAC address without risk of duplication. Assigning such large MAC addresses is forward thinking since it is anticipated that in the future every electronic or electronically controlled device, such as computers, televisions, alarm systems, heating and ventilation systems, and even household appliances, will be networked.

The 12 digit (6-byte) MAC addresses are assigned to a card by the manufacturer at the time of fabrication. The first three bytes of a MAC address are unique to the manufacturer and thus identifies the manufacturer of the card. The remaining three bytes is the card's serial number, unique to the card. In a redundant system where a single card is connected to two networks should one fail, the card is assigned two unique MAC addresses, one for each network.

FIG. 1 shows a typical Ethernet data frame. The frame comprises a preamble 10, a start frame delimiter 12, a destination MAC address 14, a source MAC address 16, a length field 18, a variable data field 20, pad bytes 22, and FCS (file control sequence) 24.

When a card connected to the network transmits a data frame, the data frame moves in both directions on the bus and is thus seen by every other card connected to the network (i.e., the data is broadcast). Only the card having the MAC destination address matching the destination address 14 in the transmitted data packet processes the data.

Since MAC addresses are readily identify a particular piece of hardware or card, they suffer the disadvantage that hardware replacement requires update of the MAC address on all platforms that communicate with a device. In other words, each time a card is pulled out of a slot connected to the network and replaced with a new card, the MAC address of the new card must be provided to all other cards on the network in order for the other cards to know how to address the new card.

This updating procedure is normally done via the IP ARP protocol (internet protocol/address resolution protocol)). Moreover, allocation of further communication addresses is dependent on the MAC address (IP address via Dynamic Host Configuration Protocol (DHCP) for example). Consequently, the change of a MAC address must be reflected in the administration of the other addresses as well (manual update of DHCP server for example).

### SUMMARY OF THE INVENTION

It is therefore an object of the invention to avoid the need to update network platforms when a card is replaced.

According to the invention, the MAC address is associated with a particular hardware location (e.g. slot) in the network rather than to the card itself. Thus, the card's MAC address assigned by the manufacturer is effectively ignored. Each slot is assigned its own MAC address. When a card is plugged into the slot for the first time it is initialized and reprogrammed with the MAC address of the slot. Thus, if a destination address in a received data frame matches the MAC address of the slot, the card will recognize the data frame. Likewise, when a Card transmits a data frame, the source address in the frame is changed to match the Slot MAC address prior to being sent over the network.

For example, Card A is inserted into slot 1. Card A is of course assigned a unique MAC address by its manufacturer. On initialization of the card software, the slot number is detected. Software then maps the slot number into a table of predefined MAC addresses, to obtain the MAC address that should be assigned to slot #1. This address is then programmed into the Card. This causes Card A to now accept all packets on the network with the programmed Slot MAC address instead of the original manufacturer assigned MAC address. When another device wishes to communicate with Card A, it does so by using the slot #1 MAC address.

This of course has the advantage that no update of additional databases/servers need be made upon hardware replacement. Further, since the MAC address is tied to a physical slot location, all other addresses (IP addresses for example) are also tied to the same slot. This is very useful in identifying sources of messages or localizing faults in the communication network. For example, if the card in slot #1 fails, the absence if corresponding packets with slot #1's IP and MAC address will be detected. This assumption can only be made according to the present invention since only cards plugged into slot #1 will ever be assigned these particular addresses.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a diagram showing a sample Ethernet data frame;

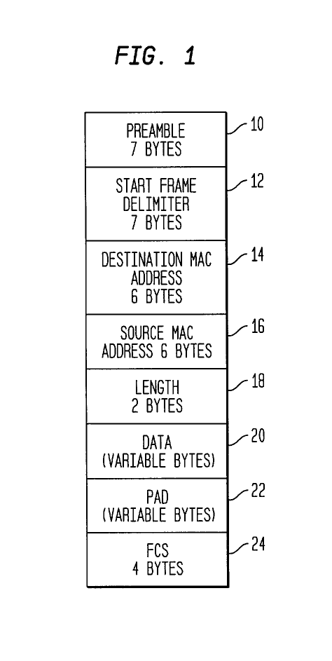

FIG. 2 is a block diagram showing a plurality of cards plugged into slots connected to a LAN;

FIG. 3A is a block diagram illustrating a slot and card arrangement receiving a data frame from the network;

FIG. 3B is a flow diagram illustrating the process steps when receiving a data frame from the network;

FIG. 4A is a block diagram illustrating a slot and card arrangement transmitting a data frame to the network;

FIG. 4B is a flow diagram illustrating the process steps when a data frame is transmitted to the network.

### DETAILED DESCRIPTION OF A DETAILED EMBODIMENT OF THE INVENTION

The present invention, while having broad range application to networks in general, is for purposes of discussion embodied in a larger communication architecture developed by Siemens Corporation, known a SURPASS.

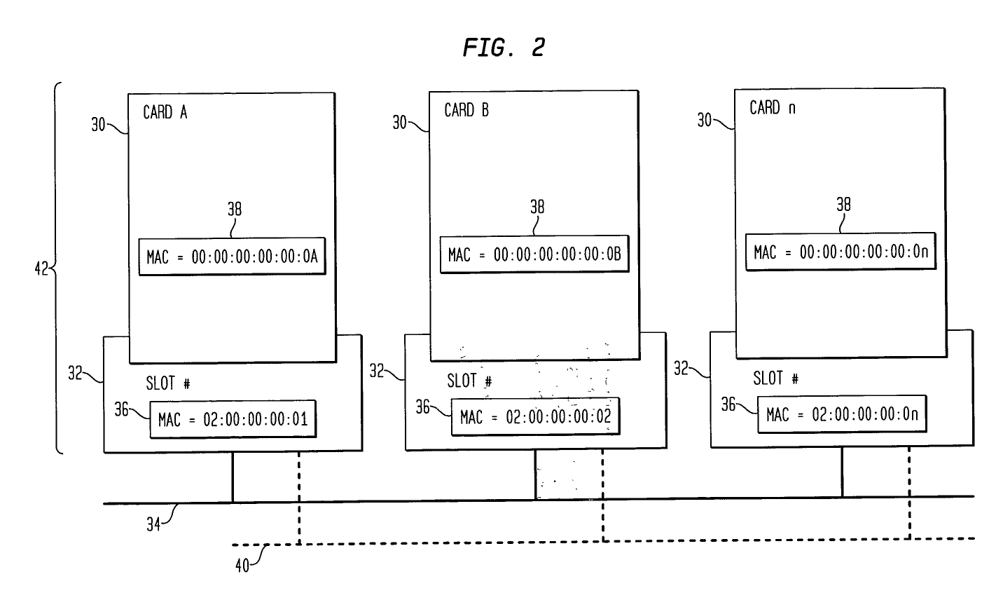

Looking forward, voice network operators must maintain and expand their voice market share while adapting their networks to accommodate data communication. This, of course, requires substantial investment. Voice communication (e.g., telephony) is traditionally carried on a circuit switched network. Digital data communications is traditionally carried on a packet switched network. SURPASS makes compatible these two types of networks yet strives to not sacrifice the specific advantages of either network. Circuit-switched networks are highly reliability under heavy loads and ideal for real-time transmission for telephone voice and video conferencing. However, their bandwidth and interfacing capabilities are limited. Alternatively, Internet Protocol/Asynchronous Transfer Mode (IP/ATM) data networks are not as reliable and not the first choice for real time communications. However, on the positive side they provide inexpensive services, such as e-mail. The SURPASS solutions provide a full range of Next Generation Network applications to meet the growing network demands. The SURPASS system comprises many main sub-components such as network card slots as shown in FIG. 2.

Referring to FIG. 2, a plurality of cards 30 are respectively labeled Card A, Card B, . . . Card N. Each of the cards 30 plugs into a network slot 34. The slots are in turn connected to a common bus 34 (e.g., an Ethernet bus). The SURPASS system includes several components, including a system of 32 cards that plug into 32 slots that fit in a rack (not shown). According to the invention, each slot 34 is assigned its own unique MAC address 36. Of course, each of the cards was previously assigned a unique MAC address 38 by its manufacturer. In the preferred embodiment, each slot 36 is connected to a second or redundant network 40 should the primary network 34 fail. Thus, each slot 32 and each card 30 have two MAC addresses, one for each network. However, for the sake of simplicity and to avoid unnecessary duplication, only the invention as it relates to the primary network 34 will be discussed in detail. Those skilled in the art will readily appreciate the invention as extended to include a redundant network 40.

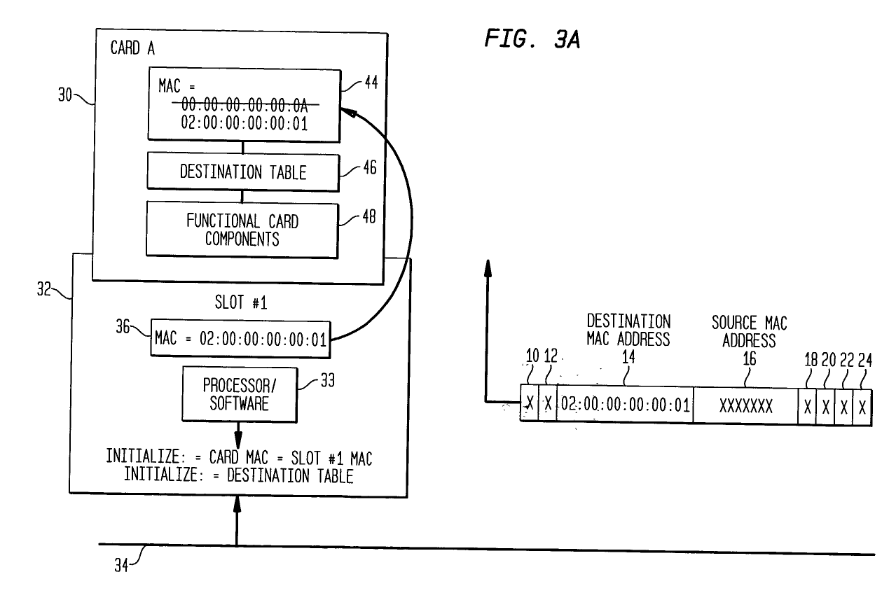

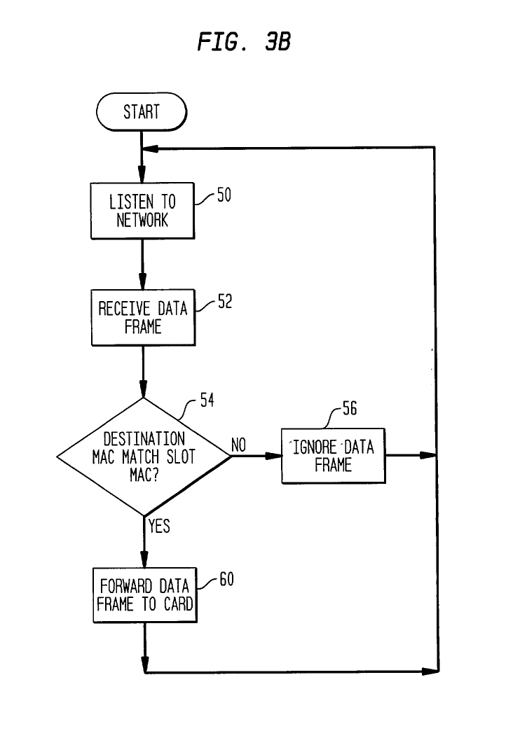

Referring to FIG. 3A, there is shown an exploited view item 42 from FIG. 2, which is used to illustrate how a data frame is received. Generally speaking, since CARD A can represent any component that can be placed on a network, it contains functional components that allows the card to perform its intended function. Since the focus of the present invention does not relate to the specific function of the card, these functional components are simply represented by functional components block 48.

As previously noted, SLOT #1 is connected to network 34 and is assigned it own MAC address, say 02:00:00:00:00:01. Card A, 30, is plugged into network SLOT #1, 32. Card A includes its own unique MAC address 44, usually stored in a memory. Here, Card A has been assigned 00:00:00:00:00:0A as a MAC address by the manufacture. When Card A is first plugged into the slot, the card is detected and software 33 initializes and reprograms the card with the MAC Address of SLOT #1, in the example 02:00:00:00:00:01. Note the first octet of the address to is “02”. This bit (bit 2) corresponds to the U/L bit or Universal/Local bit of the MAC address and indicates that the address is a programmed address and not the original one that came from the manufacturer. The software 33 may be located in the card 30. Card A also includes a destination table 46 which is initialized to include all of the MAC addresses with which CARD A can communicate with.

Referring to FIG. 3B, taken with reference to FIG. 3A, according to the invention, Slot #1 listens to the network 34 and monitors for data frames having a destination MAC address 14 of SLOT #1 that was programmed into the Ethernet interface on initialization. When a frame is received 52 the destination MAC address 14 is compared to the SLOT #1 MAC address. If there is no match, the frame is ignored 56.

As will be appreciated by those skilled in the art, the present invention makes replacing Card A simple. For example, if Card A fails or for some other reason requires replacement, all that is required is that a new card be swapped in and initialized so that the Card MAC value 35 in the SLOT 32 be updated with the Slot MAC value 36. Thus only one location needs to be updated rather then the multiple destination table updates as required when a card is swapped according to the prior art.

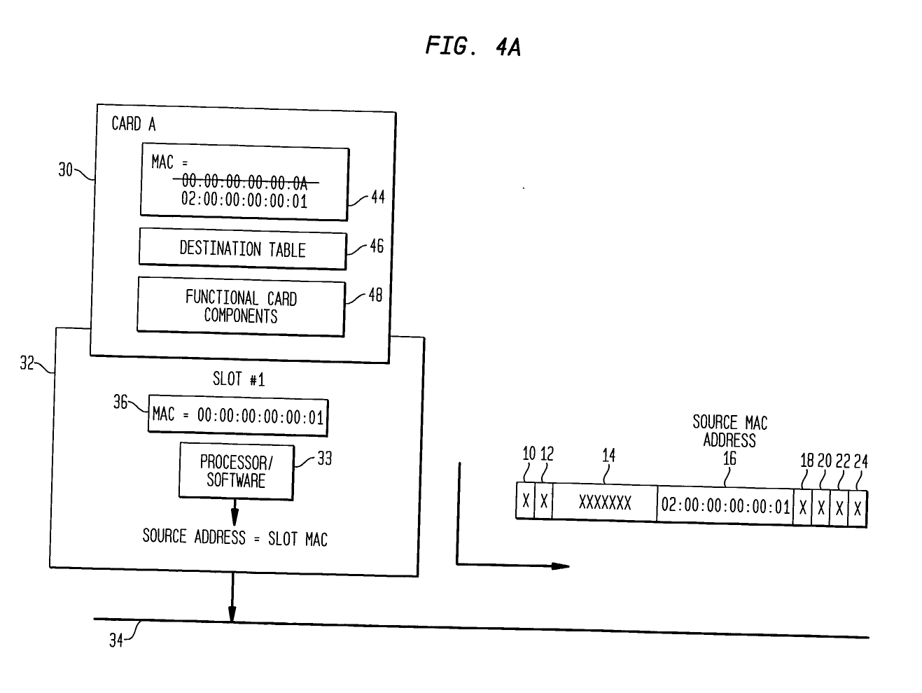

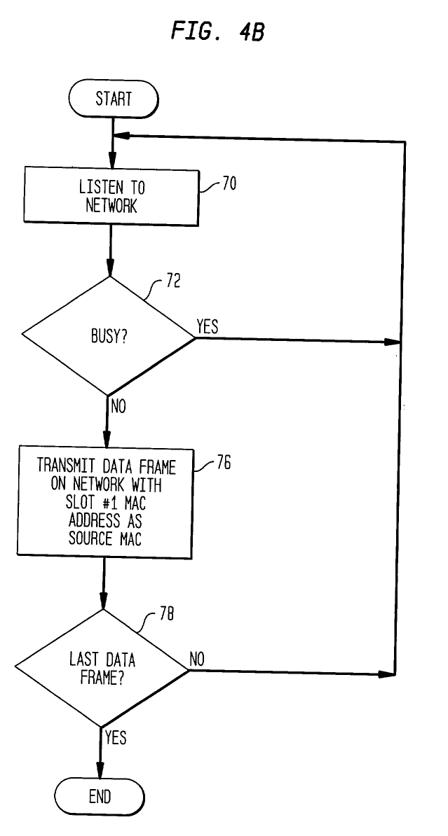

Referring now to FIG. 4A, there is shown an exploited view item 42 from FIG. 2, which is used to illustrate how a data frame is transmitted. As previously noted, SLOT #1 is connected to network 34 and is assigned it own MAC address, say 02:00:00:00:00:01. Card A, 30, is plugged into network SLOT #1, 32. Card A includes its own unique MAC address 44. Again in this example, Card A has been assigned 00:00:00:00:00:0A as a MAC address by the manufacture. Card A also includes a destination table 46 that includes all of the MAC addresses with which CARD A is aware and can communicate with as well as functional components 48 particular to the card.

Referring to FIG. 4B, taken with reference to FIG. 4A, when Card A wishes to transmit, the network 34 is listened to determine is the network is busy 70. At decision block 72, if the network is busy, then continue listening. When the network is idle, the frame is transmitted, with the source MAC address replaced by the SLOT #1 MAC address that was programmed into the Ethernet interface on initialization of the Card. Thus, the destination that receives the data frame will know that it originated from SLOT #1 regardless of what card is plugged into SLOT #1.

Among other things, this arrangement facilitates the recognition of defective cards for ease of system maintenance. In the past, if a card failed, a system administrator may monitor and note that a particular card is non-responsive or has not transmitted data for a predetermined period of time. This may indicate that the card is malfunctioning, but does not indicate the location of the card. According to the present invention, since the MAC number is ties to a physical location, rather than to a migratory card, if a card fails, the location of the failure is immediately known.

While the invention has been described in terms of a single preferred embodiment, those skilled in the art will recognize that the invention can be practiced with modification within the spirit and scope of the appended claims.

Having thus described our invention, what we claim as new and desire by Letters Patent is as follows:

1. A system for assigning a Media Access Control (MAC) address to a physical location in a network, comprising:
a slot having a physical location in a network;
a slot MAC address assigned to said slot, said slot for receiving a card having a card MAC address;
means for reprogramming the card MAC address with said slot MAC address, wherein a received data frame having said card MAC address as a destination address is ignored by the card and a received data frame having said slot MAC address is accepted by the card.

2. A system for assigning a MAC address to a physical location in a network as recited in claim 1 wherein said means for reprogramming the card MAC address is software.

3. A system for assigning a MAC address to a physical location in a network as recited in claim 1, further comprising means for initializing a destination table to include MAC addresses of other slots within the network.

4. A system for assigning a MAC address to a physical location in a network as recited in claim 1 further comprising:
a plurality of slots, each having a physical location within said network and each having a unique slot MAC address associated therewith.

5. A system for assigning a MAC address to a physical location in a network as recited in claim 4 wherein said plurality of slots comprises thirty-two slots for receiving thirty-two cards that fit into a rack.

6. A system for assigning a MAC address to a physical location in a network as recited in claim 1 further comprising:
a second network, said slot having a physical location in said second network;
a second slot MAC address assigned to said slot, said slot for receiving a card having a second card MAC address;
means for reprogramming the second card MAC address with said second slot MAC address, said second network and second slot MAC address being redundant to said network.

7. A system for assigning a MAC address to a physical location in a network as recited in claim 1 wherein the card comprises an Ethernet interface.

8. A method of for assigning a Media Access Control (MAC) address to a physical location in a network, comprising the steps of:
providing a plurality of slots connected to a physical location in a network;
assigning each of said slots a unique slot MAC address;
connecting a card having a card MAC address into one of said plurality of slots; and
initializing said card by reprogramming said card with said Slot MAC address.

9. A method of for assigning a MAC address to a physical location in a network as recited in claim 8 further comprising the step of initializing a destination table to include MAC addresses of other slots within the network.

10. A method of for assigning a MAC address to a physical location in a network as recited in claim 8 further comprising the step of providing thirty-two slots for receiving thirty-two cards that fit into a rack.

11. A method of for assigning a MAC address to a physical location in a network as recited in claim 8 further comprising the step of:
transmitting a data frame on said network with a slot address as a source address.

12. A method of for assigning a MAC address to a physical location in a network as recited in claim 11 further comprising the steps of:
monitoring the network to identify a source address that has not transmitted for a period of time; and
determining said physical location of the card and slot assigned said source address.

13. In a system for assigning a Media Access Control (MAC) address to a physical location in a network, a computer readable medium, having instructions for causing the computer to execute the steps of:
determining when a card is connected to a slot having a physical location in a network, said card having a card MAC address and said slot having a slot MAC address;
initializing said card by reprogramming said card to respond to said slot MAC address.

14. In a system for assigning a Media Access Control (MAC) address to a physical location in a network, a computer readable medium as recited in claim 13, having instructions for causing the computer to further execute the step of:
initializing a destination table in said card to include MAC addresses of other slots within the network.

15. In a system for assigning a Media Access Control (MAC) address to a physical location in a network, a computer readable medium as recited in claim 13, having instructions for causing the computer to further execute the steps of:
monitoring the network to identify a source address that has not been transmitted for a period of time; and
determining said physical location of the card and slot assigned said source address.
